(19) United States
(12) Patent Application Publication
(10) Pub. No.: US 2010/0282218 A1
(43) Pub. Date: Nov. 11, 2010

(54) DEVICE FOR REDUCING MAINLY THE CARBON DIOXIDE GENERATED BY ANY INTERNAL COMBUSTION ENGINE AND BY INDUSTRIAL ACTIVITY

(76) Inventor: Yngve Jakobsen, Peille (FR)

Correspondence Address: YOUNG & THOMPSON, 209 Madison Street, Suite 500, Alexandria, VA, 22314, US

(21) Appl. No.: 12/744,695

(22) PCT Filed: Oct. 2, 2008
(86) PCT No.: PCT/FR2008/001376

§ 371 Date: May 26, 2010

(30) Foreign Application Priority Data
Nov. 27, 2007 (FR) 0708276

(51) Int. Cl. F02M 37/04

(52) U.S. Cl. 123/495

(57) ABSTRACT

A device includes an assembly including a tank (1), a pump (4) and one or two injectors (6) for injecting a water and lime solution directly into the gas flow. The device can be used for substantially reducing the release of carbon dioxide into the atmosphere and for reducing the risks of global warming.

The present invention concerns a device to reduce the carbon dioxide produced by all internal combustion engines and industry.

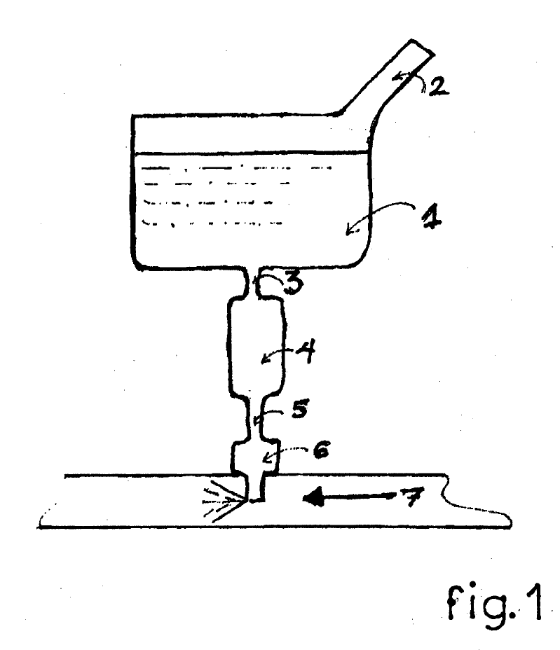

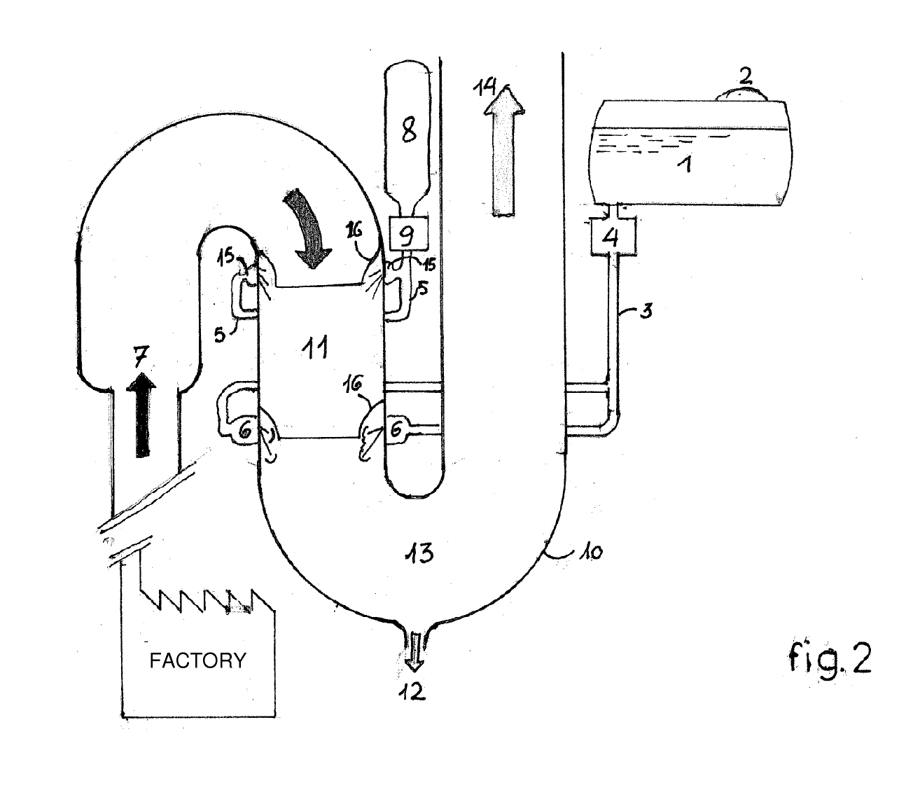

Patent DE 4038068 A1, describes an industrial application that consists in spraying lime water directly into expanded gases. The automobile application involves spraying the lime water inside a transverse container hung on the rear bumper with a submerged pump. According to FIG. 2, and with lateral accelerations, the liquid will block the incoming gas connection, and choke the engine, or block the outgoing gas connection and, in this case, the pump dries up. These two applications cannot be executed, because by spraying the lime water on the gases and after their expansion, the device, FIG. 1, only processes part of industrial gases. Once the catalytic converter became popular, the temperatures have largely exceeded 100° C. and, according to this patent, the lime water cannot be effective above 100° C.

According to patent DE 4038068 A1, lime water is manufactured by precipitating water in heated lime oxide (quicklime) and, after the chemical reaction has taken place, lime water with the formula CAD+H₂O>Ca(OH)₂ mixed with CO₂ is obtained, giving the formula; Ca(OH)₂+CO₂>CaCO₃+H₂O.

Described in patent FR 0708276, extinct lime (calcium hydroxide in powder form) is mixed with water to obtain lime water, a reagent with CO₂ according to the formula: Ca(OH)₂+CO₂+H₂O>CaCO₃+2H₂O.
The two methods and the chemical formula are not the same, the best industrial application being injection with lime water, or better, separate injection of calcium hydroxide and water.

Internal combustion engines and industry discharge a quantity of gases considered toxic (CO, HC, NOx, etc.). and dangerous for humans, the fauna and flora. For a long time carbon dioxide was not considered dangerous for humans but at concentrations above 5% of the volume of air inhaled, humans and fauna could feel some discomfort. For several years scientists have been ringing the alarm; carbon dioxide heats the atmosphere resulting in global warming. To produce 1000 kilos of cement, cement factories discharge 760 kilos of CO₂ into the air. A cement factory producing 500,000 tons of cement discharges some 380,000 tons of CO₂ every year. Since the catalytic converter became popular, gasoline engines have been discharging ˜15.7% of carbon dioxide by volume, which correspond to stoichiometric combustion, (14.7 kg of air for 1 kg of gasoline). This concerns all vehicles produced since 1992; CO₂ discharge by vehicles produced before 1992 can be lower, although the discharge of toxic gases is higher. Diesel engines discharge less CO₂ compared to gasoline engines although the road haulage industry is mostly equipped with diesel engines.

The most recent estimates for road transport are that 35 million metric tons of CO₂ are discharged to the air in France every year.

The device according to the invention brings a substantial decrease in the discharge of CO₂ by all internal combustion engines and industry.

According to a first characteristic shown in FIG. 1/3: a tank (1) containing lime water, obtained by mixing calcium hydroxide powder and water, with filling port (2) and exit port (3) in its lower part.

The device according to the invention has a second characteristic: a high-pressure injection pump (4) positioned under the tank, and tube (3) connecting it thereto.

The device according to the invention has a third characteristic: an injector (6) and its tube (5) connecting it to the pump that is able to inject the solution into the stream of exhaust gases (7).

The device according to the invention has a fourth characteristic: it can be dimensioned and calibrated so that it can be adapted to fit on all internal combustion vehicles, and industrial systems discharging to the air.

By using a high pressure pump to inject the lime water into the exhaust gas flow (calcium hydroxide mixed with water), or into industrial gases before they expand, the exhaust gases/lime water are better mixed resulting in a more thorough chemical reaction according to the formula:

Ca(OH)₂+CO₂+H₂O=>CaCO₃+2H₂O.

This injection makes a substantial reduction of CO₂ content in the total discharge. CaCO₃ is commonly called conchitic sand (classified as a sediment conchitic sand, rock conchitic limestone, or mineral calcite), which is an easily found natural resource.

The device according to the invention has a fifth characteristic illustrated in FIGS. 2/3 and 3/3: the ability to inject the calcium hydroxide and the water separately so that the quantity of calcium hydroxide and water to be injected can be better controlled, avoiding the injector becoming clogged by very hot gases.

The device according to the invention has a sixth characteristic: it discharges two volumes of water, 2H₂O after the chemical reaction. This water can be recovered for reinjection into a water tank when installed on an industrial system. To ensure the long life of the exhaust silencer, an exhaust silencer in a synthetic material can be used as described in patent FR2884861, entitled: Exhaust silencer in synthetic rubber for two or four-stroke internal combustion engines.

### ILLUSTRATION FIG. 1.

1—Water tank
2—Filling port
3—Tube
4—Injection pump
5—Tube
6—Injector
7—Gas stream

### ILLUSTRATION FIG. 2

1—Water tank
2—Filling port
3—Tubes
4—Water injection pump
5—Tubes
6—Water injectors
7—Industrial gases
8—Silo of calcium hydroxide
9—Pneumatic injection pump
10—Device
11—First reaction chamber
12—Recovery of precipitates and water
13—Second reaction chamber
14—Discharge of clean gases
15—Calcium hydroxide injectors
16—Thermal funnels with Venturi effect

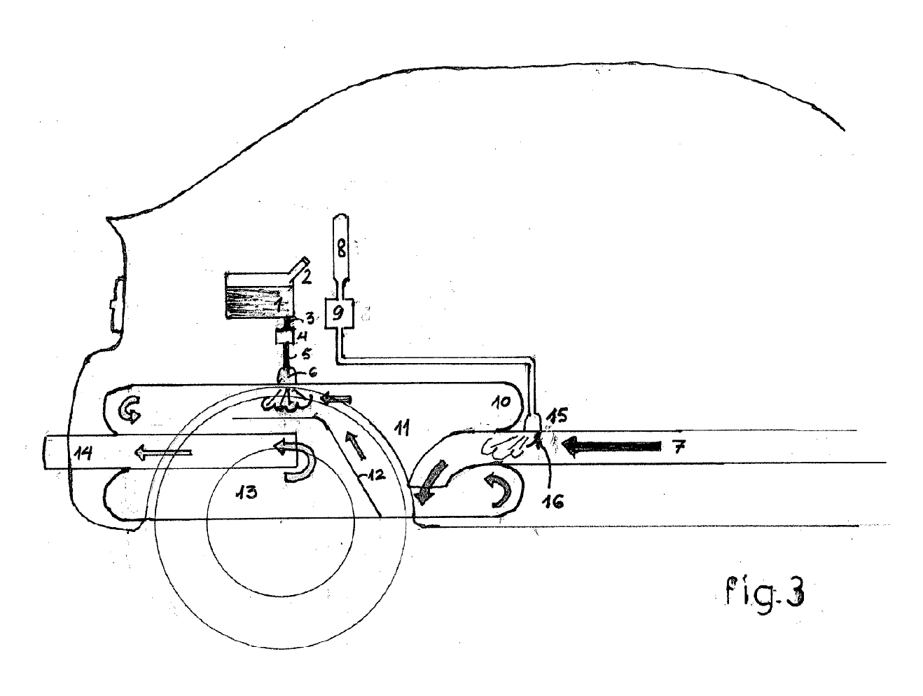

### ILLUSTRATION FIG. 3

1—Water tank
2—Filling port
3—Tube
4—Water injection pump
5—Tube
6—Water injector
7—Exhaust fumes
8—Tank of calcium hydroxide
9—Pneumatic injection pump
10—Exhaust silencer
11—First reaction chamber
12—Partition
13—Second reaction chamber
14—Discharge of clean gases
15—Calcium hydroxide injector
16—Thermal screen with Venturi effect

1-9. (canceled)

10. Process to reduce mainly the rejection of carbon dioxide produced by all internal combustion engines and industrial activities, characterized in that it comprises a tank (1) filled with lime water, an injection pump (4) placed in the lower part of the tank, an injector (6), the assembly connected by tubes (3 and 5), which makes it possible to inject the lime water continuously and directly into gases produced by industrial activities, or directly into exhaust gases.

11. Use of the device according to claim 10, characterized in that it can be adapted and calibrated to fit all types of internal combustion engine vehicles, and adapted or calibrated for all discharges of gases produced by industrial activities.

12. Device according to claim 10, characterized in that pump (4), placed in the lower part of the tank, allows the use of an injection pump.

13. Device according to claim 10, characterized in that the injection of lime water, which is heated by the gases to be treated, increases its capacity to eliminate CO₂.

14. Device according to claim 10, characterized in that the calcium hydroxide and water can be injected separately in order to better adapt the quantity of calcium hydroxide and water to be injected, particularly by taking account of the moisture content of the gases to be treated, and thus avoiding obstruction of the injector by very hot gases.

15. Device according to the claim 10, characterized in that the injection of the lime water directly into gases produced by industrial activities and into exhaust gases of vehicles fixes the nitrogen (Nox) and hydrocarbon residues (HC).

16. Process according to claim 10, characterized in that water can be recovered after the chemical reaction, and reintroduced into the tank of the device in industrial systems.

17. Process according to claim 10, characterized in that the precipitate formed by the chemical reaction is limestone, and therefore stable.
